(19) United States
(12) Patent Application Publication
(10) Pub. No.: US 2025/0356151 A1
(43) Pub. Date: Nov. 20, 2025

(54) OPTICAL INFORMATION READING DEVICE

(71) Applicant: KEYENCE CORPORATION, Osaka (JP)

(72) Inventors: Hidehito Kubota, Osaka-shi (JP); Masahito Saiki, Osaka-shi (JP); Tomoki Ueno, Osaka-shi (JP)

(73) Assignee: KEYENCE CORPORATION, Osaka (JP)

(21) Appl. No.: 19/181,714

(22) Filed: Apr. 17, 2025

(30) Foreign Application Priority Data
May 17, 2024 (JP) 2024-080573

(51) Int. Cl. G06K 7/14; G06K 7/10

(52) U.S. Cl. CPC G06K 7/1413; G06K 7/10881

(57) ABSTRACT

The imaging device comprises a first fixed-focus camera, a second fixed-focus camera, and a variable focus camera. The control device reads information of the symbol based on the first image from the first fixed-focus camera, the second image from the second fixed-focus camera, and the third image from the variable focus camera. The control device controls the focal length changing device of the variable focus camera such that the focal length of the variable focus camera is longer than the first focal length of the first fixed-focus camera and shorter than the second focal length of the second fixed-focus camera. The control device reads the information of the symbol based on the third image, which is focused at a distance farther than the first image and closer than the second image, generated by the variable focus camera under the controlled focal length.

### CROSS-REFERENCE TO RELATED APPLICATIONS

The present application claims foreign priority based on Japanese Patent Application No. 2024-080573, filed May 17, 2024, the contents of which are incorporated herein by reference.

### BACKGROUND OF THE INVENTION

### 1. Technical Field

This disclosure relates to optical information reading devices such as handy terminals.

### 2. Description of the Related Art

An optical information reading device is a device that captures an image of a symbol to be read and reads the information of the captured symbol. The optical information reading device described in JP 2022-055005 A irradiates the symbol with aiming light (aimer light) before capturing an image of the symbol.

JP 2022-055005 A discloses an optical information reading device that uses two cameras: a fixed focus camera and an autofocus camera.

When it is determined that imaging by the fixed focus camera is unsuitable for reading symbols, the autofocus camera is used. This reduces the frequency of using the autofocus camera, thereby preventing an increase in imaging time and shortening of mechanical lifespan.

JP 2020-177306 A discloses an optical information reading device that reduces the discrepancy in the reading area by configuring a fixed focus camera with four eyes.

However, in the optical information reading device described in JP 2022-055005 A, since it performs a sequential operation of activating the fixed focus camera after activating the autofocus camera, there is a problem that it takes time for processing when it is determined that imaging by the fixed focus camera is unsuitable for reading symbols.

In the optical information reading device described in JP 2020-177306 A, even for symbols such as codes at the same distance, as the code size becomes smaller, the distance range in which images can be generated at a decodable level becomes narrower. Therefore, there is a possibility that a range difficult to read, that is, a gap, may occur.

### SUMMARY OF THE INVENTION

Therefore, the purpose of this disclosure is to enable rapid reading of symbols in an optical information reading device without causing areas where reading is difficult.

To achieve this purpose, an optical information reading device according to the first aspect of this disclosure, which captures an image of a symbol to be read and reads information of the symbol, comprises an imaging device and a control device. The imaging device includes:
a first fixed focus camera including a first fixed focus optical system having a first focal length and receiving reflected light that is incident on the symbol and reflected by the symbol, and a first imaging element that converts the light received by the first fixed focus optical system into an electrical signal to generate a first image,
a second fixed focus camera including a second fixed focus optical system having a second focal length longer than the first focal length and receiving reflected light that is incident on the symbol and reflected by the symbol, and a second imaging element that converts the light received by the second fixed focus optical system into an electrical signal to generate a second image focused at a longer distance than the first image,
a variable focus camera including a variable focus optical system whose focal length is variable and which receives reflected light that is incident on the symbol and reflected by the symbol, a third imaging element that converts the light received by the variable focus optical system into an electrical signal to generate a third image, and a focal length changing device that changes the focal length of the variable focus optical system,

The optical information reading device further comprises a control device capable of reading symbol information based on the first image, second image, and third image,

The control device:
controls the focal length changing device such that the focal length of the variable focus optical system becomes longer than the first focal length and shorter than the second focal length, and
reads symbol information based on the third image focused at a distance farther than the first image and closer than the second image, which is generated by the variable focus camera under the focal length.

According to the optical information reading device of the first aspect of this disclosure, it is possible to read between the reading distance of the first fixed-focus camera for short distances and the reading distance of the second fixed-focus camera for long distances using a variable focus camera. Therefore, it is possible to expand the entire readable distance range without sacrificing the readable range on the short-distance side by the first fixed-focus camera and the readable range on the long-distance side by the second fixed-focus camera. Furthermore, it is not necessary to sequentially perform processing by the fixed-focus camera and processing by the variable focus camera, and these can be processed simultaneously, enabling rapid reading of symbols.

### BRIEF DESCRIPTION OF THE DRAWINGS

FIG. 1 is a perspective view showing the appearance of an optical information reading device according to an embodiment of this disclosure.

FIG. 2 is another perspective view showing the appearance of the same optical information reading device.

FIG. 3 is a block diagram of the same optical information reading device.

FIG. 4 is a cross-sectional view showing the configuration of a focal length changing device in the same optical information reading device.

FIG. 5 is a diagram showing an arrangement example of cameras and illumination elements in the same optical information reading device.

FIG. 6 is a diagram showing another arrangement example of cameras and illumination elements in the same optical information reading device.

FIG. 7 is a diagram showing yet another arrangement example of cameras and illumination elements in the same optical information reading device.

FIG. 8 is a diagram showing an example of operating ranges of fixed focus cameras and variable focus cameras in the same optical information reading device.

FIG. 9 is a diagram showing another example of operating ranges of fixed focus cameras and variable focus cameras in the same optical information reading device.

FIG. 10 is a diagram showing yet another example of operating ranges of fixed focus cameras and variable focus cameras in the same optical information reading device.

FIG. 11 is a diagram showing yet another example of operating ranges of fixed focus cameras and variable focus cameras in the same optical information reading device.

FIG. 12 is a diagram showing yet another example of operating ranges of fixed focus cameras and variable focus cameras in the same optical information reading device.

FIG. 13 is a diagram showing the entire operating ranges of fixed focus cameras and variable focus cameras in the same optical information reading device.

FIG. 14 is a diagram showing an example of operating ranges of fixed focus cameras and variable focus cameras in an optical information reading device that is not an embodiment of this disclosure.

FIG. 15 is a diagram showing the entire operating range of fixed focus cameras in another optical information reading device that is not an embodiment of this disclosure.

FIG. 16 is a diagram showing the entire operating range of fixed focus cameras in yet another optical information reading device that is not an embodiment of this disclosure.

FIG. 17 is a diagram showing the entire operating range of fixed focus cameras in yet another optical information reading device that is not an embodiment of this disclosure.

FIG. 18 is an enlarged view of the essential part in FIG. 3.

FIG. 19 is a flowchart showing the operation of the optical information reading device according to an embodiment of this disclosure.

FIG. 20 is a time chart showing the operation of the same optical information reading device.

FIG. 21 is a diagram showing the data processing of images from fixed focus cameras and variable focus cameras by multiple cores.

FIG. 22 is another diagram showing the data processing of images from fixed focus cameras and variable focus cameras by multiple cores.

### DETAILED DESCRIPTION

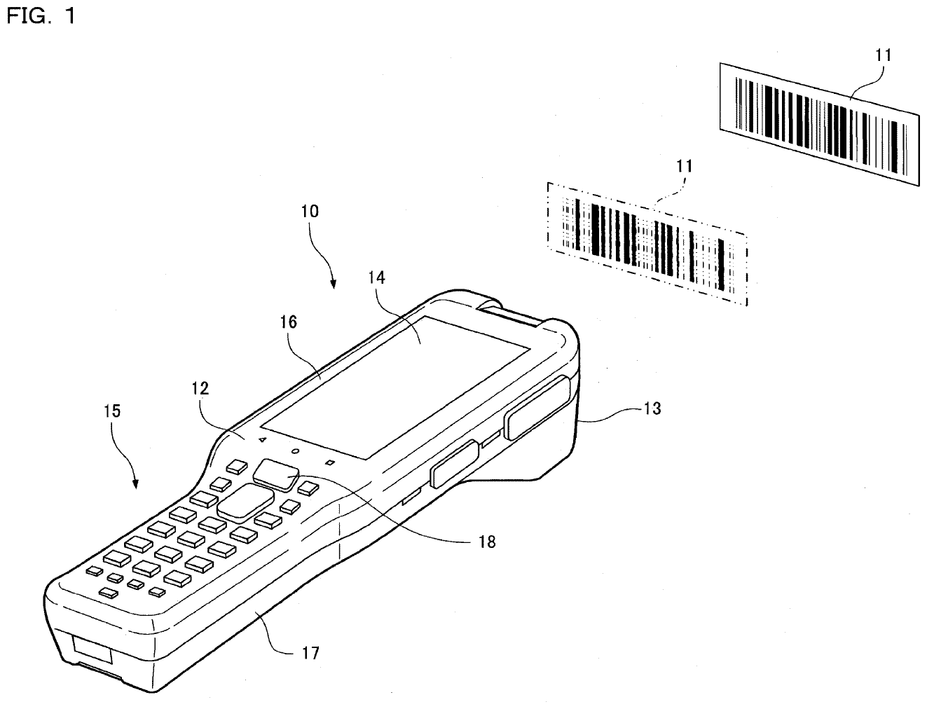

FIGS. 1 and 2 are perspective views showing an example of the appearance of an optical information reading device of an embodiment of this disclosure. The optical information reading device is a terminal device for reading symbols such as barcodes and two-dimensional codes. The optical information reading device includes not only handheld scanners that read and output symbols, but also optical information reading devices 10 with a handy terminal structure as shown in the figure that perform arbitrary data processing such as registering read information and data matching, as well as business-use PDAs.

The symbol 11 (FIG. 1) to be read includes standardized codes such as barcodes and two-dimensional codes, proprietary standard codes, as well as character strings composed of characters and numbers. These symbols are directly printed on the surface of products, which are the objects to be read, or on the surface of shelves storing the products, or printed on labels attached to the product surface. Reading a symbol generally means decoding information encoded in the symbol. As a special case, when the symbol is a character string, reading the symbol means optical character recognition (OCR) of characters and numbers.

The optical information reading device 10 of the handy terminal configuration shown in the figure has a racket-shaped casing 12 that is formed long in one direction. At the tip portion of the casing 12, an imaging module 13 as an imaging device is provided for optically reading a symbol 11, which is the reading target. The details of the imaging module 13 will be described later.

On the top surface of the casing 12, a display 14 is provided on one end side of the casing 12, and a key arrangement part 15 is provided on the other end side of the casing 12. The display 14 is provided in the display portion 16 of the optical information reading device 10, and the key arrangement part 15 is provided in the grip portion 17. The user, who is the operator of the optical information reading device 10, grips the grip portion 17 with their hand and operates each operation key of the key arrangement part 15 arranged on the grip portion 17 while referring to the display content of the display 14 provided in the display portion 16. The casing is made wide in the display portion 16 and narrow in the grip portion 17. This makes it easy for the user to hold the grip portion 17.

The display 14 displays various types of information such as images of the symbol 11, which is the reading target, captured by the imaging module 13, information decoded from the symbol 11, and other setting information. The display 14 is composed of, for example, a liquid crystal display (LCD) or organic EL. The display 14 may also be configured as a touch panel. The display 14 configured as a touch panel can also function as a key input section.

Multiple operation keys such as numeric keypad for performing various operations, power key, and function keys are arranged in the key arrangement part 15. The optical information reading device 10 is provided with a trigger key 18. When the operator operates the trigger key 18, the data collection timing for collecting information of the symbol 11 is defined. In other words, when the imaging module 13 detects that the trigger key 18 has been operated, it starts the imaging process. In the imaging process, the imaging module 13 receives the reflected light that has been incident on and reflected by the symbol 11 to be read, converts it into an electrical signal, and generates image data. In other words, the trigger key 18 defines the trigger signal. The trigger key 18 is not limited to a physical key, but may be a virtual key displayed on a user interface, for example.

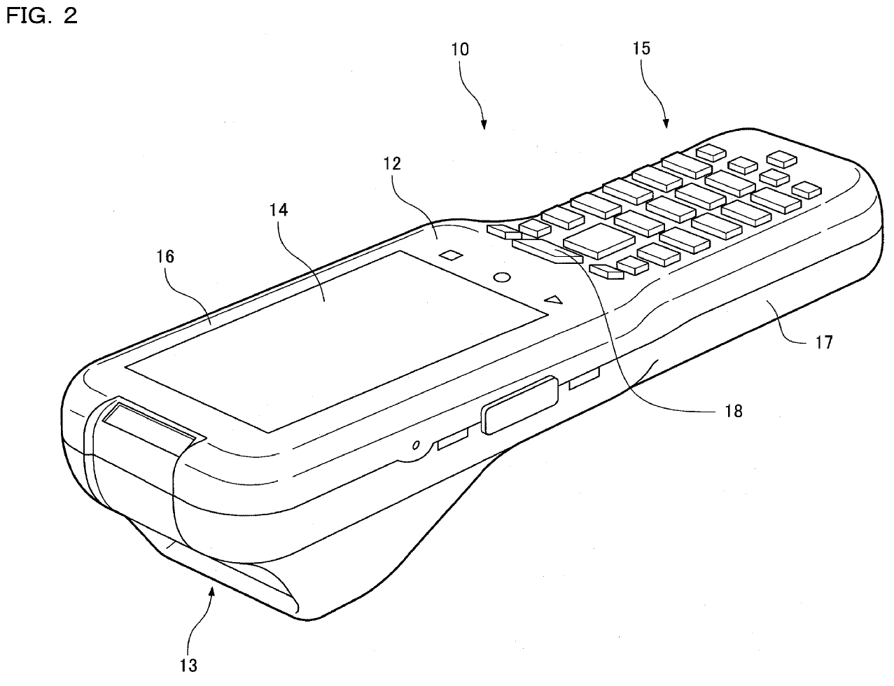

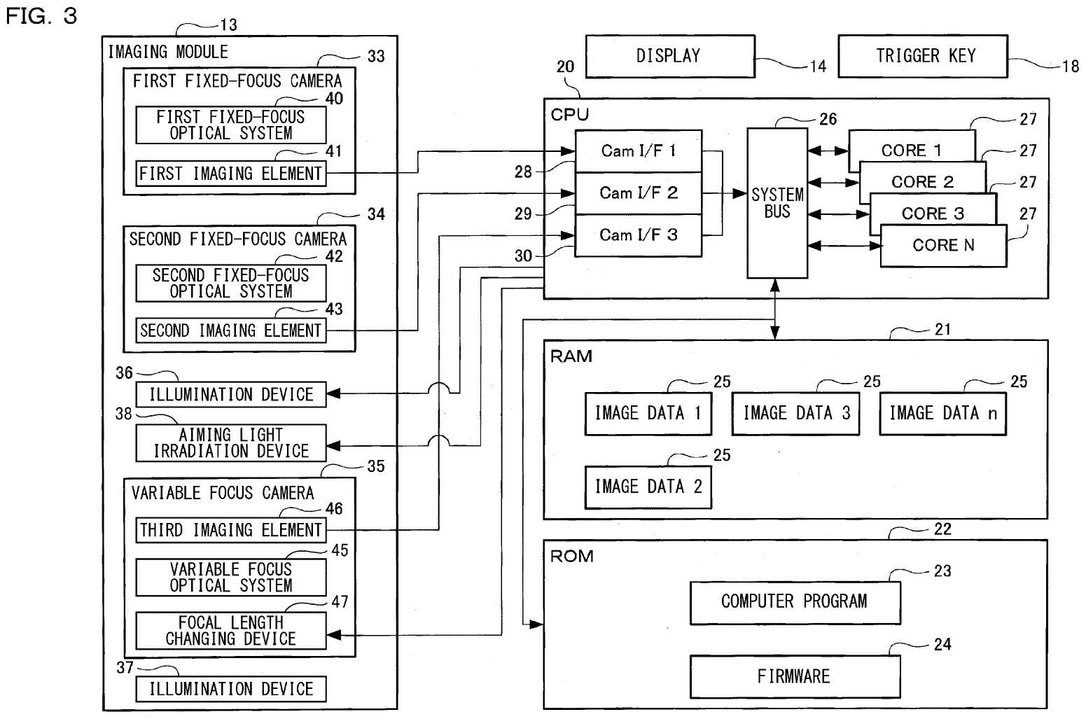

FIG. 3 is a block diagram of the optical information reading device 10. As shown in this FIG. 3, the optical information reading device 10 includes the aforementioned imaging module 13, the aforementioned display 14, the aforementioned trigger key 18, a control device 20 such as a CPU that controls the operation of the optical information reading device 10, RAM 21, and ROM 22.

The control device 20 is connected to the aforementioned hardware components of the optical information reading device 10 via an internal system bus 26 and the like. This allows the control device 20 to control the operation of the aforementioned hardware components and execute various software functions according to the computer program 23 and firmware 24 stored in ROM 22. Such a control device 20 can be suitably realized by a CPU, MPU, SoC, ASIC, or the like. RAM 21 is composed of volatile memory such as SRAM or SDRAM, where load modules are expanded during the execution of computer programs, and temporary image data 25, namely “image data 1”, “image data 2”, . . . “image data n”, generated during the execution of computer programs are stored.

The control device 20 includes, in addition to the internal system bus 26 mentioned above, multiple cores 27, and image capture interfaces 28, 29, 30 for acquiring images from cameras provided in the imaging module 13.

The configuration of the imaging module 13 as an imaging device will be explained. The imaging module 13 includes a first fixed-focus camera 33, a second fixed-focus camera 34, and a variable focus camera 35. The imaging module 13 further includes an illumination device 36 for the fixed-focus cameras 33, 34, an illumination device 37 for the variable focus camera 35, and an aiming light irradiation device 38.

The first fixed-focus camera 33 has a fixed-focus configuration and includes a first fixed-focus optical system 40 and a first imaging element 41. The first fixed-focus optical system 40 has a fixed first focal length. The first fixed-focus optical system 40 receives reflected light that is reflected by the symbol 11 in FIG. 1 when the emitted light from the illumination device 36 is incident on the symbol 11. The first imaging element 41 converts the light received by the first fixed-focus optical system 40 into an electrical signal to generate a first image. The image data of the first image is sent to the control device 20, captured by the image capture interface 28 of the control device 20, and stored in the RAM 21 as image data 25.

The second fixed-focus camera 34 has the same configuration as the first fixed-focus camera 33. That is, the second fixed-focus camera 34 has a fixed-focus configuration and includes a second fixed-focus optical system 42 and a second imaging element 43. The second fixed-focus optical system 42 has a fixed second focal length. The fixed second focal length of the second fixed-focus optical system 42 is longer than the fixed first focal length of the first fixed-focus optical system 40. In other words, the second fixed-focus camera 34 equipped with the second fixed-focus optical system 42 has a longer focal length than the first fixed-focus camera 33 equipped with the first fixed-focus optical system 40, and therefore can capture images of symbols 11 that exist at a position farther than the imageable range of the first fixed-focus camera 33. Conversely, the first fixed-focus camera 33 equipped with the first fixed-focus optical system 40 has a shorter focal length than the second fixed-focus camera 34 equipped with the second fixed-focus optical system 42, and therefore can capture images of symbols 11 that exist at a position closer than the imageable range of the second fixed-focus camera 34.

The second fixed-focus optical system 42 of the second fixed-focus camera 34 receives reflected light that is reflected by the symbol 11 in FIG. 1 when the emitted light from the illumination device 36 is incident on the symbol 11. The second imaging element 43 converts the light received by the second fixed-focus optical system 42 into an electrical signal to generate the second image. The image data of the second image is sent to the control device 20, captured by the image capture interface 29 of the control device 20, and stored in the RAM 21 as other image data 25.

The variable focus camera 35 has a variable focal length. Specifically, the variable focus camera 35 includes a variable focus optical system 45, a third imaging element 46, and a focal length changing device 47. The variable focus optical system 45 receives reflected light that is reflected by the symbol 11 in FIG. 1 when the emitted light from the illumination device 37 is incident on the symbol 11. The third imaging element 46 converts the light received by the variable focus optical system 45 into an electrical signal to generate a third image. The image data of the third image is sent to the control device 20, captured by the image capture interface 30 of the control device 20, and stored in the RAM 21 as yet another image data 25.

The focal length changing device 47 changes the focal length of the variable focus optical system 45. The configuration of the focal length changing device 47 for changing the focal length of the variable focus optical system 45 can be any arbitrary one. For example, the focal length changing device 47 can be configured with a device for changing the focal position of the variable focus optical system 45. In that case, the focal length of the variable focus optical system 45 is changed by changing the focal position by changing the position of the lens constituting the optical system 45 along the optical axis. The focal length changing device 47 is drive-controlled by the control device 20.

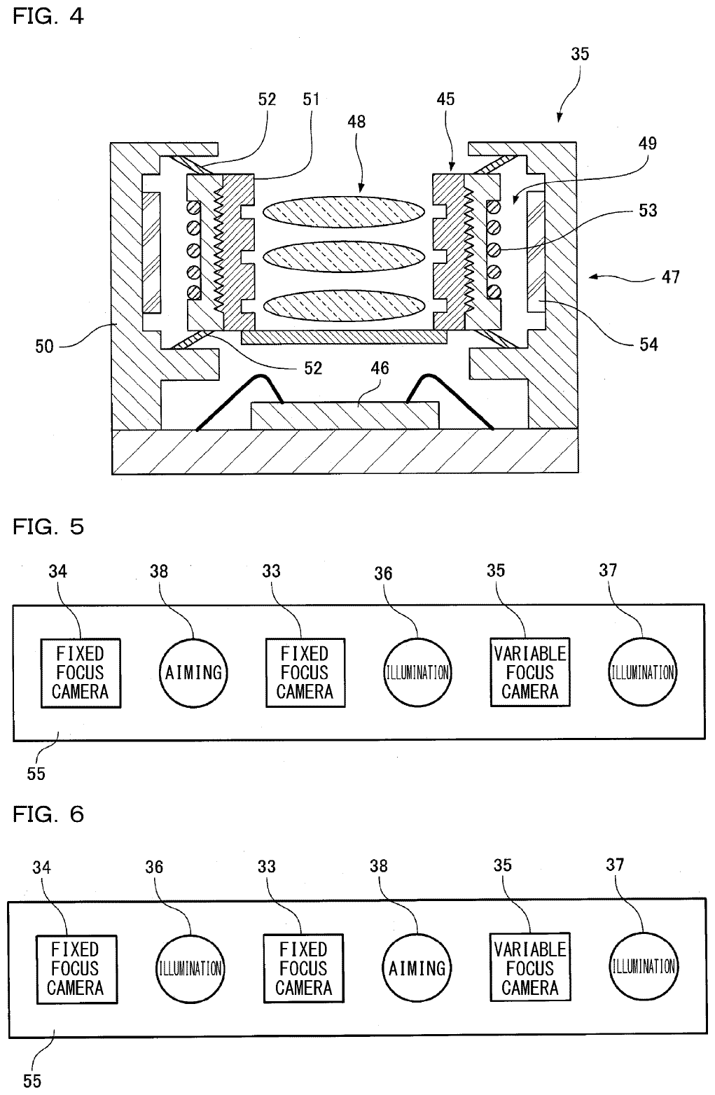

A specific example of the focal length changing device 47 is shown in FIG. 4. In the example of FIG. 4, the focal length changing device 47 provided in the variable focus camera 35 includes a voice coil motor (VCM) 49 as a mechanism for mechanically moving the lens unit 48 of the variable focus optical system 45 along its optical axis. Specifically, inside the casing 50 of the variable focus camera 35, the variable focus optical system 45 including the lens unit 48 and the third imaging element 46 are arranged. The lens unit 48 is held by a holder 51, and the holder 51 is supported by the casing via a spring 52 such as a disc spring. The voice coil motor 49 includes a coil 53 provided on the holder 51 and a magnet 54 attached to the casing 50 and arranged to face the coil 53. When current flows through the coil 53, the coil 53 receives a force from the magnet 54, and when this force acting on the coil 53 becomes greater than the force from the spring 52, the lens unit 48 is mechanically moved along its optical axis. The variable focus optical system may also be a liquid lens or a deformable lens capable of adjusting focal length by applying force to a layer formed of material having flexibility (for example, thin glass layer).

The first imaging element 41 of the first fixed-focus camera 33 and the second imaging element 43 of the second fixed-focus camera 34 are both global shutter type image sensors using CMOS. In other words, both the first fixed-focus camera 33 and the second fixed-focus camera 34 are what are called scan camera modules. In contrast, the third imaging element 46 of the variable focus camera 35 is a rolling shutter type color image sensor. That is, the variable focus camera 35 is what is called a color camera module.

The field of view ranges of the first and second fixed focus cameras 33, 34 and the field of view range of the variable focus camera 35 are differentiated, making it possible to capture a wider range in a single operation.

The aiming light irradiation device 38 irradiates aiming light. The image captured by any of the cameras 33, 34, 35 after irradiating the aiming light with this aiming light irradiation device 38 is called an aiming image.

The arrangement of the first fixed-focus camera 33, the second fixed-focus camera 34, the variable focus camera 35, the illumination device 36, the illumination device 37, and the aiming light irradiation device 38 in the imaging module 13 is optional. For example, as shown in FIGS. 5 and 6, the first fixed-focus camera 33, the second fixed-focus camera 34, the variable focus camera 35, the illumination device 36, the illumination device 37, and the aiming light irradiation device 38 can be arranged in a straight line along the window 55 formed in the imaging module 13 shown in FIGS. 1 and 2.

In the example of FIG. 5, the second fixed-focus camera 34, the aiming light irradiation device 38, the first fixed-focus camera 33, the illumination device 36 for the fixed-focus cameras 33, 34, the variable focus camera 35, and the illumination device 37 for the variable focus camera 35 are arranged in this order in a straight line. By arranging them in a straight line like this, the imaging module 13 can be configured to be thin.

In the example of FIG. 6, the second fixed-focus camera 34, the illumination device 36 for the fixed-focus cameras 33 and 34, the first fixed-focus camera 33, the aiming light irradiation device 38, the variable focus camera 35, and the illumination device 37 for the variable focus camera 35 are arranged in this order in a straight line. In this case as well, by arranging them in a straight line as in the example of FIG. 5, the imaging module 13 can be configured to be thin.

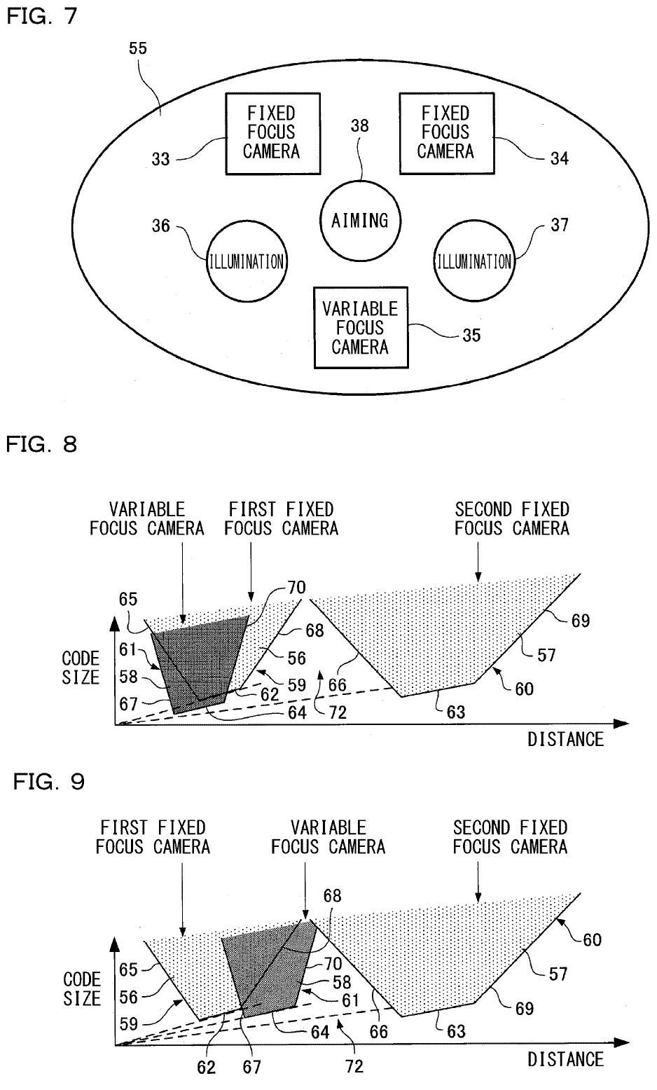

FIG. 7 shows an example of an arrangement that prioritizes the performance of the imaging module 13 over its thinness. In this example of FIG. 7, the aiming light irradiation device 38 is positioned at the center of the window 55, and the first fixed-focus camera 33, the second fixed-focus camera 34, the illumination device 37 for the variable focus camera 35, the variable focus camera 35, and the illumination device 36 for the fixed-focus cameras 33, 34 are arranged in this order surrounding the aiming light irradiation device 38. With this configuration where the aiming light irradiation device 38 is positioned at the center, the reading accuracy of the targeted symbol 11 can be enhanced in the optical information reading device shown in FIG. 1.

The following advantages are obtained by providing a first fixed-focus camera 33, a second fixed-focus camera 34 with a longer focal length than the first fixed-focus camera, and a variable focus camera 35. Specifically, there may be a third area where the symbol 11 cannot be read by either the first fixed-focus camera 33 or the second fixed-focus camera 34, between a first area within a first distance range from the first fixed-focus camera 33 where the symbol 11 can be read by the first fixed-focus camera 33, and a second area within a second distance range from the second fixed-focus camera 34 where the symbol 11 can be read by the second fixed-focus camera 34. In this case, in the third area, the symbol 11 can be read by controlling the focal length of the variable focus camera 35 to be within this area. As a result, the symbol 11 can be read over a wide range.

The following is a detailed explanation of this point. FIGS. 8 to 12 are diagrams in which the horizontal axis represents the distance from the optical information reading device 10 to the symbol, and the vertical axis represents the code size of the symbol 11 which is the reading target of the optical information reading device 10.

In FIGS. 8 to 12, the first readable area 56, which is the area where the code of the symbol 11 can be read by the first fixed-focus camera 33, the second readable area 57, which is the area where the code of the symbol 11 can be read by the second fixed-focus camera 34, and the third readable area 58, which is the area where the code of the symbol 11 can be read by the variable focus camera 35, are all areas above the bottomed V-shaped first limit line 59, second limit line 60, and third limit line 61 in FIGS. 8 to 12.

In any of the readable areas 56, 57, and 58, at the focal distance position of the cameras 33, 34, and 35 and its vicinity, the bottom parts 62, 63, and 64 of the V-shaped bottomed limit lines 59, 60, and 61 correspond. In other words, at the focal distance of the cameras 33, 34, and 35 and its vicinity, even symbols 11 with small code sizes can be read. In contrast, as the distance from the focal distance position of the cameras 33, 34, and 35 increases, the limit lines 59, 60, and 61 correspond to a pair of inclined portions 65, 66, 67 and 68, 69, 70 in the V-shaped bottomed form. That is, as the distance from the focal distance position of the cameras 33, 34, and 35 increases, the readable code size gradually becomes larger. In other words, as the distance from the focal distance position of the cameras 33, 34, and 35 increases, symbols with small code sizes gradually become unreadable.

In FIGS. 8 to 12, the bottom portions 62, 63, 64 of the bottomed V-shaped limit lines 59, 60, 61 are inclined to gently rise upward to the right as they move away from the cameras 33, 34, 35. This corresponds to the phenomenon that the minimum readable code size gradually increases as it moves away from the cameras 33, 34, 35.

As shown in FIGS. 8 to 12, the bottom portion 62 of the first limit line 59 of the first fixed-focus camera 33 is positioned at a distance close to the optical information reading device 10. In contrast, the bottom portion 63 of the second limit line 60 of the second fixed-focus camera 34 is positioned at a distance farther from the optical information reading device 10 than the bottom portion 62 of the first limit line 59 of the first fixed-focus camera 33. This corresponds to the fact that the fixed second focal length of the second fixed-focus optical system 42 of the second fixed-focus camera 34 is longer than the fixed first focal length of the first fixed-focus optical system 40 of the first fixed-focus camera 33.

As described above, the first limit line 59 defining the first readable area 56, which is the readable area of the code of symbol 11 by the first fixed-focus camera 33, and the second limit line 60 defining the second readable area 57, which is the readable area of the code of symbol 11 by the second fixed-focus camera 34, are both bottomed V-shaped. Therefore, along the horizontal axis in FIGS. 8 to 12, between the first readable area 56 and the second readable area 57, there exists an unreadable area 72 where small code size symbols 11 that can be read at the bottom part 62 of the first limit line 59 of the first fixed-focus camera 33 or the bottom part 63 of the second limit line 60 of the second fixed-focus camera 34 cannot be read by the first fixed-focus camera 33 and the second fixed-focus camera 34. This unreadable area 72 appears as an upward-pointed triangular area in FIGS. 8 to 12.

The variable focus camera 35 equipped with the variable focus optical system 45 is capable of reading small code size symbols 11 around the bottom part 62 of the first limit line 59 of the first fixed-focus camera 33 and the bottom part 63 of the second limit line 60 of the second fixed-focus camera 34, in the unreadable area 72 where the first fixed-focus camera 33 and the second fixed-focus camera 34 cannot read.

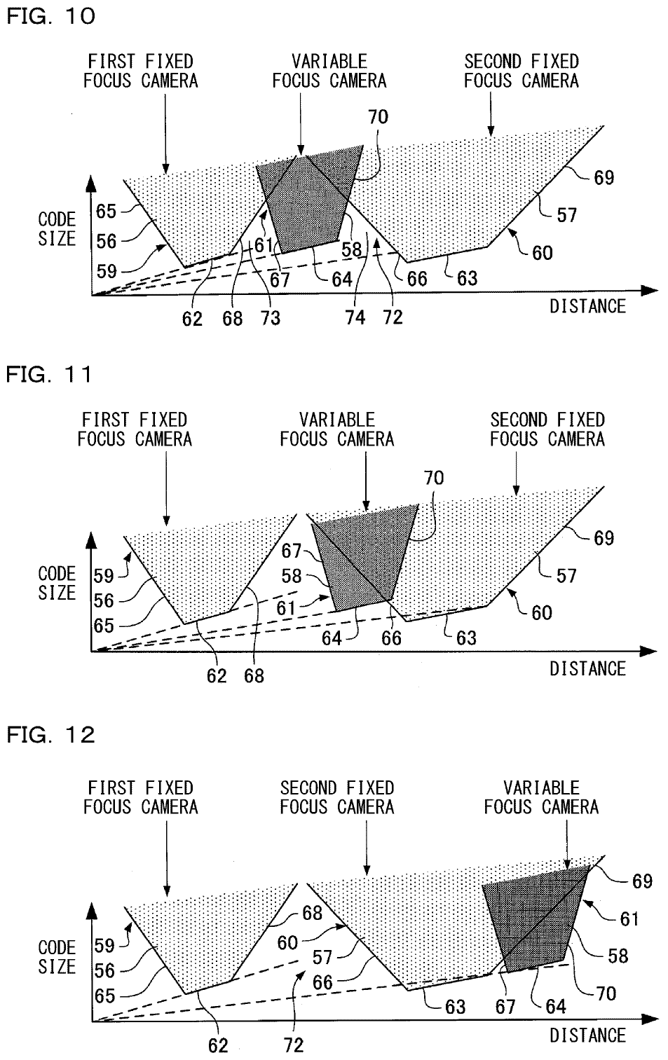

FIG. 10 shows the state when the focal length of the variable focus optical system 45 of the variable focus camera 35 is set to an intermediate value between the focal length of the first fixed-focus camera 33 and the focal length of the second fixed-focus camera 34. At this time, the third readable area 58 of the variable focus camera 35 is positioned in the portion along the horizontal axis of FIG. 10, corresponding to the unreadable area 72, which is between the first readable area 56 of the first fixed-focus camera 33 and the second readable area 57 of the second fixed-focus camera 34. In other words, the bottom part 64 of the third limit line 61 defining the third readable area 58 of the variable focus camera 35 is positioned in the portion along the horizontal axis of FIG. 10, between the bottom part 62 of the first limit line 59 defining the first readable area 56 and the bottom part 63 of the second limit line 60 defining the second readable area 57.

Thereby, in the unreadable area 72 where the fixed focus cameras 33, 34 cannot read the symbol 11, the variable focus camera 35 can read the symbol 11. As a result, the symbol 11 at a position close to the optical information reading device 10 can be read by the first fixed focus camera 33, the symbol 11 at a position far from the optical information reading device 10 can be read by the second fixed focus camera 34, and the symbol 11 at an intermediate position between the close position and the far position can be read by the variable focus camera 35. Therefore, according to the optical information reading device 10, symbols 11 existing over a wide range of distances from this optical information reading device 10 can all be reliably read.

Depending on how the first to third readable areas 56, 57, 58 are set, it may be possible to reliably read symbols 11 that exist over a wide range of distances from the optical information reading device 10, using only the first and second readable areas 56, 57, and the third readable area 58 with the focal length changed by the variable focus camera 35, as described above. However, if the first to third readable areas 56, 57, 58 are not set or cannot be set to a very wide range, as shown in FIG. 10, there may be narrow unreadable areas 73, 74 that are similar to those mentioned above, at least between the first readable area 56 and the third readable area 58, or between the second readable area 57 and the third readable area 58.

In this case, as shown in FIG. 9, by making the focal length of the variable focus camera 35 slightly shorter than in the case of FIG. 10, the third readable area 58 can be brought closer to the first readable area 56 along the horizontal axis of the figure. This can eliminate the occurrence of the unreadable area 73. Similarly, as shown in FIG. 11, by making the focal length of the variable focus camera 35 slightly longer than in the case of FIG. 10 and bringing the third readable area 58 closer to the second readable area 57 along the horizontal axis of the figure, the occurrence of the unreadable area 74 can be eliminated.

The variable focus camera 35 can set its focal length shorter than that of the first fixed-focus camera 33 and longer than that of the second fixed-focus camera 34 by taking a large variable range of its focal length.

FIG. 8 shows the distribution of the first to third readable areas 56, 57, 58 when the focal length of the variable focus camera 35 is set shorter than the focal length of the first fixed focus camera 33. As shown in the figure, the third readable area 58 of the variable focus camera 35 is positioned closer to the optical information reading device 10 than the first readable area 56 of the first fixed focus camera 33.

FIG. 12 shows the distribution of the first to third readable areas 56, 57, and 58 when the focal length of the variable focus camera 35 is set longer than the focal length of the second fixed focus camera 34. As illustrated, the third readable area 58 of the variable focus camera 35 is positioned farther from the optical information reading device 10 than the second readable area 57 of the second fixed focus camera 34.

By configuring in this way, as shown in FIGS. 9 to 11, compared to the case where the third readable area 58 of the variable focus camera 35 is set only between the first readable area 56 of the first fixed-focus camera 33 and the second readable area 57 of the second fixed-focus camera 34, the width of the readable area of the optical information reading device 10 along the horizontal axis of the figure can be increased. In other words, compared to the case where the displacement area of the third readable area 58 based on the change in focal length of the variable focus camera 35 is set only between the first readable area 56 of the first fixed-focus camera 33 and the second readable area 57 of the second fixed-focus camera 34, it becomes possible to reliably read symbols 11 that exist at positions with a larger range of distances from the optical information reading device 10.

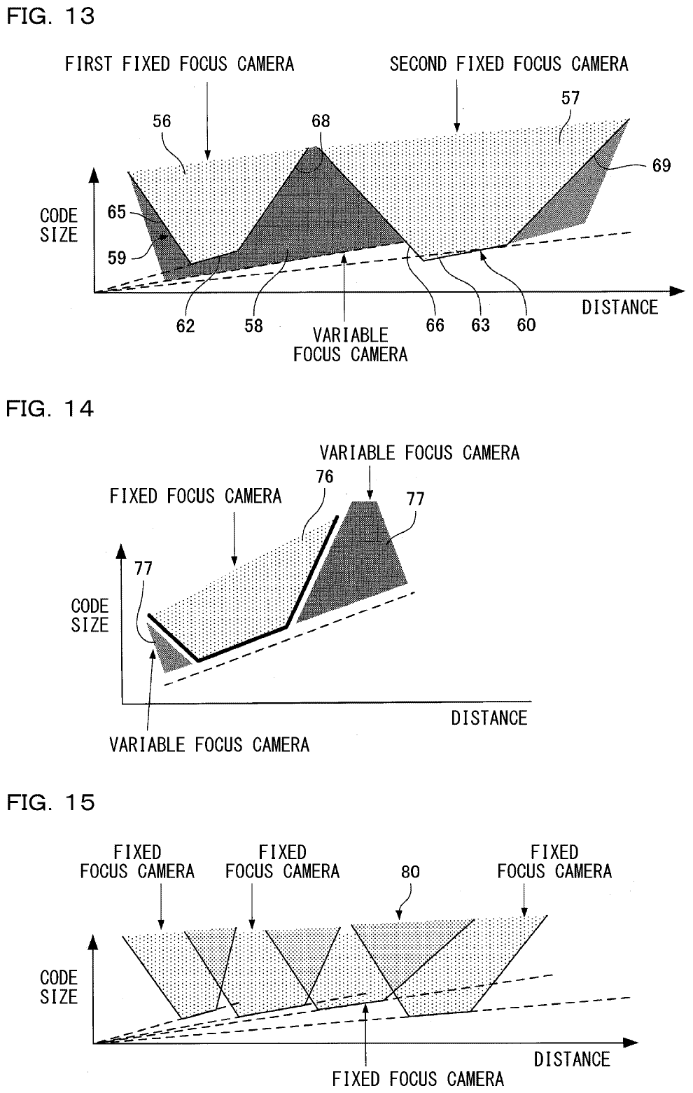

FIG. 13 shows the entire range of readable areas 56, 57, and 58 by the first fixed-focus camera 33, the second fixed-focus camera 34, and the variable focus camera 35 when the focal length of the variable focus camera 35 changes as shown in FIGS. 8 to 12. Specifically, the readable area 58 by the variable focus camera 35 corresponds to the range of each changed focal length in the variable focus camera 35, but FIG. 13 comprehensively shows the entire range of the third readable area 58 that can be set by the variable focus camera 35. From FIG. 13, it can be understood that with the variable focus camera 35 provided, in addition to the first readable area 56 by the first fixed-focus camera 33 and the second readable area 57 by the second fixed-focus camera 34, the third readable area 58 by the variable focus camera 35 is added, resulting in a wide range of readable areas.

When operating the variable focus camera 35, it is necessary to perform operations such as changing its focal length, which makes the operation more complex. However, there exists a first readable area 56 by the first fixed-focus camera 33 and a second readable area 57 by the second fixed-focus camera 34, and within the range where these first readable area 56 and second readable area 57 exist, it is not necessary to operate the variable focus camera 35. Therefore, compared to operating only the variable focus camera 35 over the entire range, the operability and controllability can be improved.

For example, as shown in FIG. 14, it is possible to set a readable area 76 by a single fixed-focus camera and a readable area 77 by a single variable focus camera. However, in this case, compared to the case where two fixed-focus cameras 33, 34 are provided as shown in FIG. 13, the range of the readable areas 76, 77 becomes significantly narrower. It is of course possible to set the readable area 77 by the variable focus camera wider such that the range of the readable area does not become narrow. However, in that case, similar to the above-mentioned case, it becomes necessary to frequently change the focal length of the variable focus camera 35 to operate it. As a result, the operability and controllability of the variable focus camera 35 will decrease accordingly.

As shown in FIG. 15, by installing four fixed-focus cameras with different focal lengths, the range of the readable area 80 can be expanded to the same range as in the case of FIG. 13. However, in that case, problems arise such as the device configuration becoming complex due to an excessive number of fixed-focus cameras, decreased controllability when operating the cameras, and excessive processing volume of data obtained from each camera.

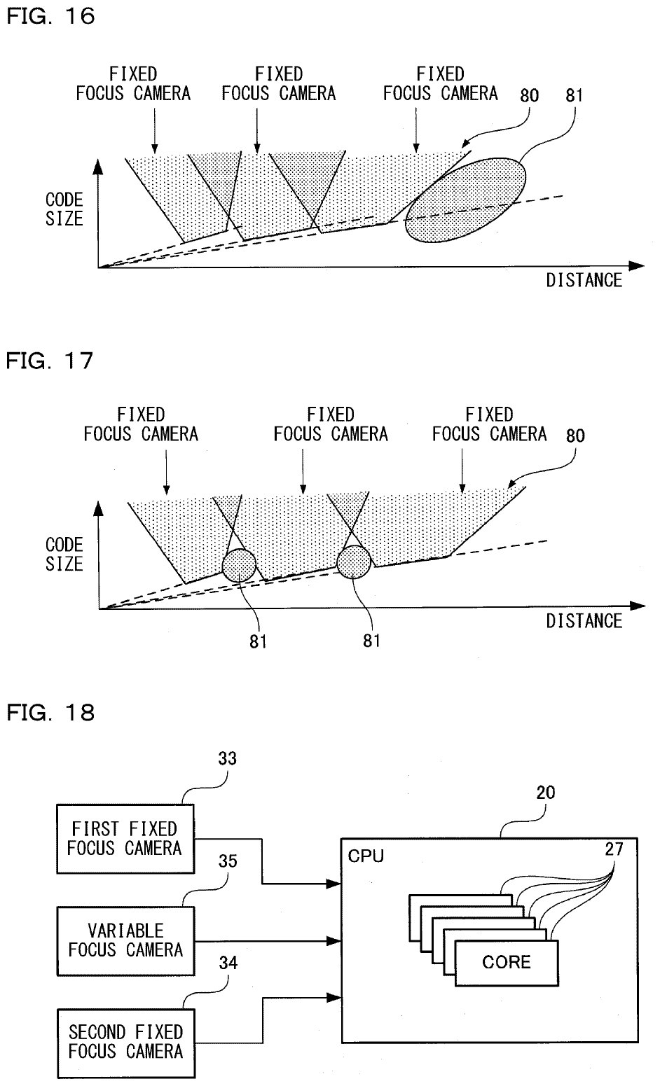

To solve this problem, for example, as shown in FIG. 16, the number of fixed focus cameras can be increased to three. However, in that case, as illustrated, the range of the readable area 80 becomes narrower. In FIG. 16, compared to the case in FIG. 15, an unreadable area 81 is generated on the long-distance side from the optical information reading device 10.

In order to solve the problem of the occurrence of the unreadable area 81 shown in FIG. 16, it is also possible to expand the range of the readable area 80 by significantly differentiating the focal lengths of three fixed-focus cameras, as shown in FIG. 17. However, in that case, as illustrated, unreadable areas 81 occur between the readable areas 80 of adjacent fixed-focus cameras.

After all, none of the means shown in FIG. 14 to FIG. 17 can obtain the advantages of providing the first fixed-focus camera 33, the second fixed-focus camera 34, and the variable focus camera 35 as described above.

In the above embodiment, the third readable area 58 of the variable focus optical system mainly changes to fill the unreadable area 72 between the first readable area 56 by the first fixed-focus camera 33 and the second readable area 57 by the second fixed-focus camera 34. In contrast, for example, as shown in FIG. 16, a modified example can be considered where the fixed-focus camera having the rightmost readable area 80 is replaced with a variable focus camera, allowing the variable focus camera to read the unreadable area 81 that occurs on the long-distance side from the optical information reading device 10.

However, in this case as well, since the readable areas 80 of multiple fixed-focus cameras are adjacent to each other, it is necessary to increase the degree of overlap of the readable areas 80 of multiple fixed-focus cameras to make the unreadable area 81 smaller, which results in a shorter readable distance. Additionally, by positioning the readable range of the variable focus camera farther than that of multiple fixed-focus cameras, the angle of view becomes relatively narrow. As a result, when the variable focus camera tries to read a code on the near side, there is a higher possibility that the code may not fit entirely within the field of view due to the upper limit of the angle of view.

Even when positioning the readable range of the variable focus camera closer than that of multiple fixed-focus cameras, it is necessary to increase the degree of overlap of the readable areas 80 of the multiple fixed-focus cameras to make the unreadable area 81 smaller, which in turn shortens the readable distance. Additionally, by positioning the readable range of the variable focus camera closer than that of multiple fixed-focus cameras, the angle of view becomes relatively wider. As a result, when the variable focus camera attempts to read a code at a longer distance, there is a higher possibility that the resolution will be insufficient due to the lower limit of the angle of view.

A method for processing image data acquired by fixed focus cameras 33, 34 and variable focus camera 35 using the control device 20 will be explained. FIG. 18 is an enlarged view showing the essential part of FIG. 3. As shown in FIG. 3 and FIG. 18, the control device (CPU) 20 is composed of multiple cores 27, 27, . . . . And separate cores 27 are assigned to the first fixed focus camera 33, the second fixed focus camera 34, and the variable focus camera 35 respectively. This enables simultaneous execution of processing of images from the first fixed focus camera 33, processing of images from the second fixed focus camera 34, and processing of images from the variable focus camera 35 by individual cores 27, 27, . . .

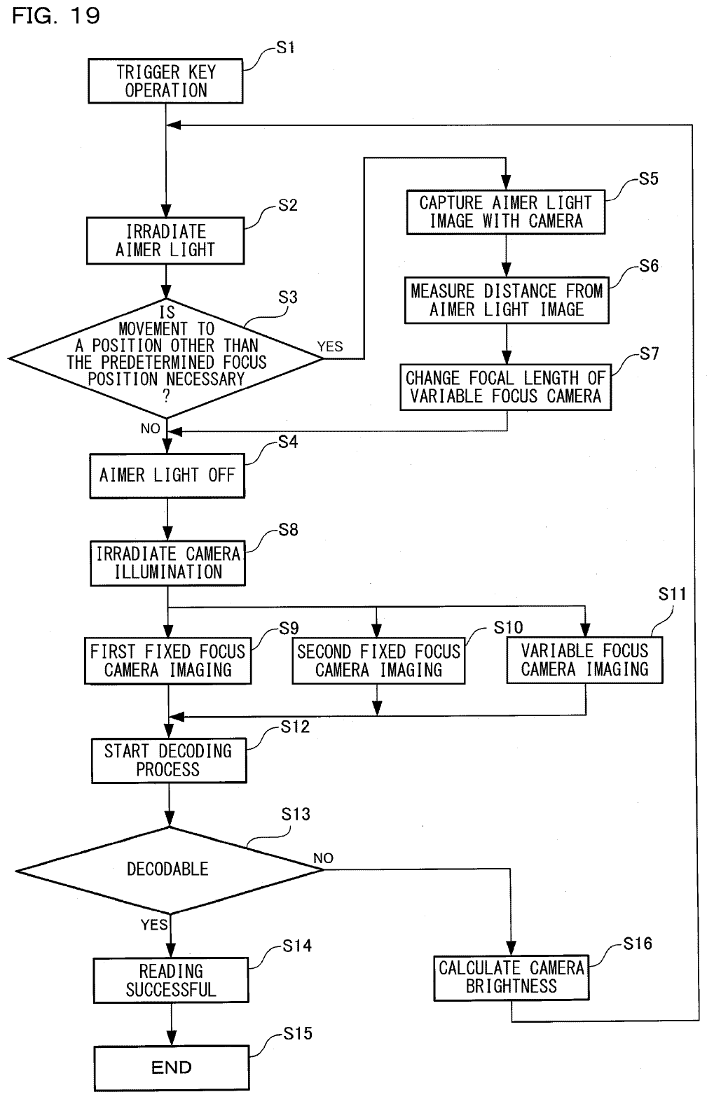

FIG. 19 is a flowchart for explaining the method of reading image data by the control device 20.

The optical information reading device 10 shown in FIGS. 1 and 2 is provided with a trigger key 18 (see FIGS. 1 to 3) that the operator operates when starting to use this device 10. In step S1 of FIG. 19, when the trigger key 18 is operated by the operator, aiming light, that is, aimer light, is irradiated from the aiming light irradiation device 38 in FIG. 3 towards the object to be read (step S2).

After the trigger key 18 is operated, during the first reading process, the focal length of the variable focus camera 35 is set to a predetermined distance between the focal length of the first fixed focus camera 33 and the focal length of the second fixed focus camera 34, as shown in FIG. 10. If it is not set to that distance, the focal length changing device 47 sets it to that distance. Hereinafter, this position of the focal length of the variable focus camera 35 is referred to as the “predetermined focus position”, and its data can be stored, that is, memorized in the ROM 22 or RAM 21 shown in FIG. 3.

In step S3, it is determined whether it is necessary to move the focal length position of the variable focus camera 35 to a position other than the predetermined focus position. However, as mentioned above, during the first reading process after the trigger key 18 is operated, the focal length of the variable focus camera 35 is set to a predetermined distance between the focal lengths of the first fixed focus camera 33 and the second fixed focus camera 34, as shown in FIG. 10. Therefore, during the first reading process after the trigger key 18 is operated, it is determined that movement is unnecessary, and the process proceeds to step S4. In step S4, the aimer light irradiated in step S2 is turned off. This is because the aimer light becomes unnecessary during the symbol 11 reading process.

Although details will be described later, when the symbol 11 cannot be read in the first reading process after the trigger key 18 is operated, the process returns to step S2, and step S3 is executed again after the aimer light is re-irradiated. In this case, based on the fact that the symbol 11 could not be read, in step S3, it is determined that it is necessary to move the focal length position of the variable focus camera 35 to a position other than the predetermined focus position.

As a result, the process proceeds to step S5, where one of the three cameras 33, 34, and 35 captures the aimer light reflected from the symbol 11. This allows for measuring the distance to the symbol 11 as described below. It should be noted that when measuring distance using aimer light in this manner, it is necessary for the aimer to be captured relatively clearly in the camera image. Additionally, it is necessary for the entire aimer to be present within the camera's field of view.

In step S6, the distance to the symbol 11 is measured from the captured image of the aimer light. The image of the aimer light can be acquired by at least one of the three cameras 33, 34, and 35. For example, since there is a certain relationship between the distance to the symbol 11 and the output values such as the output voltage of the acquired image by the aimer light, by memorizing this relationship, the distance to the symbol 11 can be measured from the output value of the acquired image. Alternatively, since there is a certain relationship between the horizontal position of the symbol 11 in the acquired image by the aimer light and the output value of the acquired image, by memorizing this relationship, the distance to the symbol 11 can also be measured from the output value of the acquired image. Alternatively, the distance to the symbol 11 can be measured using the time-of-flight method, or by adjusting the focus based on the contrast of the image. The distance to the symbol 11 can also be estimated using the phase difference method. In short, the method for measuring the distance to the symbol 11 is optional.

In the next step S7, the focal length of the variable focus camera 35 is changed based on the measured distance to the symbol 11. Then, the process moves to step S4 to turn off the aimer light. Specifically, although not illustrated, the control device 20 includes a focus determination unit for determining the focal length of the variable focus camera 35. The control device 20 then drives the focal length changing device 47 such that the focal length of the variable focus camera 35 becomes the focal length determined by the focus determination unit.

After that, the reading of symbol 11 is executed from step S8 onwards. First, in step S8, the illumination devices 36 and 37 for cameras 33, 34, and 35 are turned on, and illumination light is irradiated towards symbol 11. It is optional whether to use both illumination devices 36 and 37, or only one of them. The operator of the optical information reading device 10 may manually set how to use them, or it may be automatically set according to the brightness of the environment.

As mentioned above, both the first imaging element 41 of the first fixed-focus camera 33 and the second imaging element 43 of the second fixed-focus camera 34 are global shutter type image sensors using CMOS, while the third imaging element 46 of the variable focus camera 35 is a rolling shutter type color image sensor. In other words, both the first fixed-focus camera 33 and the second fixed-focus camera 34 are what are called scan camera modules. The variable focus camera 35 is what is called a color camera module. Correspondingly, the illumination devices 36 and 37 irradiate multiple or single pulses of light as illumination light.

When illumination light is irradiated toward the symbol 11, imaging processes by the three cameras 33, 34, and 35 are performed simultaneously in steps S9, S10, and S11. This imaging process can be implemented, for example, by sending an imaging trigger signal from the control device 20 to each of the cameras 33, 34, and 35.

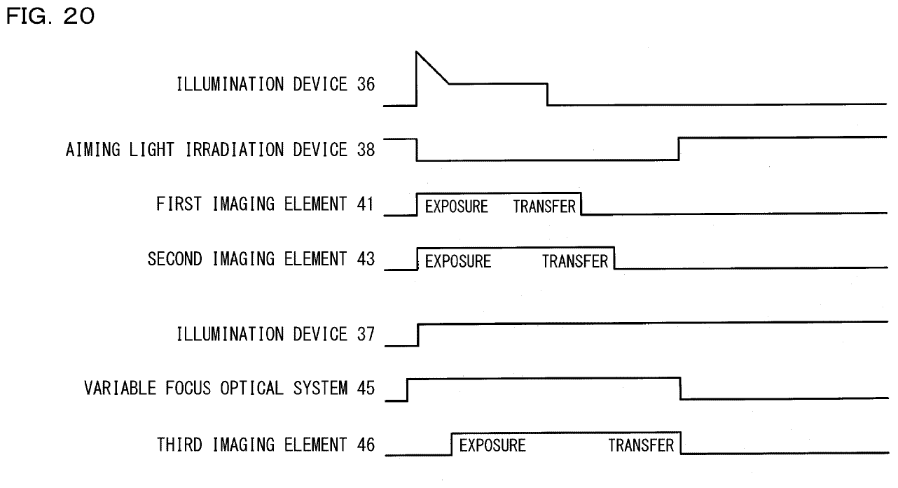

FIG. 20 shows a timing chart corresponding to Steps S4, S8, S9, S10, and S11 in FIG. 19. The illumination device 36 for the fixed-focus camera shown in FIG. 3 exhibits the light emission characteristics as shown in FIG. 20. Specifically, as mentioned above, since the scan camera module is of the global shutter type, all pixels of the image sensor are exposed simultaneously, and the exposure time is relatively short. Therefore, the illumination device 36 for the fixed-focus camera is required to emit light with a large amount of light instantancously. This is represented in the timing chart of FIG. 20, and the illumination device 36 for the fixed-focus camera shows a tendency for the initial rise to be instantancously high.

In FIG. 20, following the illumination device 36 for the fixed focus camera, the light emission characteristics of the aiming light irradiation device 38, that is, the light emission characteristics of the aimer light, are shown. As shown in the flowchart in FIG. 19, in step S4, the aimer light is turned off and then the illumination device 36 for the fixed focus camera is turned on, which is indicated in the timing chart in FIG. 20.

In FIG. 20, following the timing chart of the aimer light, the operation of the CMOS, which is the first imaging element 41 of the scan camera module, i.e., the first fixed-focus camera 33, is shown. The first imaging element 41 is exposed corresponding to the illumination device 36 emitting light and forms an image (Step S9 in FIG. 19), and the formed image is transferred to the control device (CPU) 20 shown in FIG. 3 and stored in RAM 21. Similarly, the CMOS, which is the second imaging element 43 of the second fixed-focus camera 34, is also exposed corresponding to the illumination device 36 emitting light and forms an image (Step S10 in FIG. 19), and the formed image is transferred to the control device (CPU) 20 shown in FIG. 3 and stored in RAM 21.

In FIG. 20, following the time chart for the second imaging element 43 of the second fixed-focus camera 34, there are time charts for the operation of the illumination device 37 for the variable focus camera, the operation of the variable focus optical system 45 of the variable focus camera 35, and the operation of the CMOS which is the third imaging element 46 of the variable focus camera 35, in this order. As shown in the figure, the variable focus optical system 45 starts operation in advance before the illumination device 37 turns on, and the illumination device 37 is turned on simultaneously with the illumination device 36.

The operation of the CMOS, which is the third imaging element 46 of the variable focus camera 35, will be explained in detail. The variable focus camera 35, also called a color camera module, has a timing discrepancy between the first row and the last row because the third imaging element 46 is of a rolling shutter type. Therefore, when receiving the aforementioned instantaneously large amount of light from the illumination device 36 for the fixed focus cameras 33, 34, the brightness difference between the first row and the last row in the image obtained by the third imaging element 46 becomes large. To avoid this, as shown in FIG. 20, the start of exposure by the third imaging element 46, that is, the start of operation of the third imaging element 46, is set after a predetermined period has elapsed following the end of the instantaneous rise shown in the figure and the stabilization of the light amount from the illumination device 36 for fixed focus cameras 33, 34. The third imaging element 46, in this slightly delayed state, is exposed based on light emission from illumination device 37 to form an image (Step S11 in FIG. 19), and formed image is transferred to control device (CPU) 20 shown in FIG. 3 and stored in RAM21.

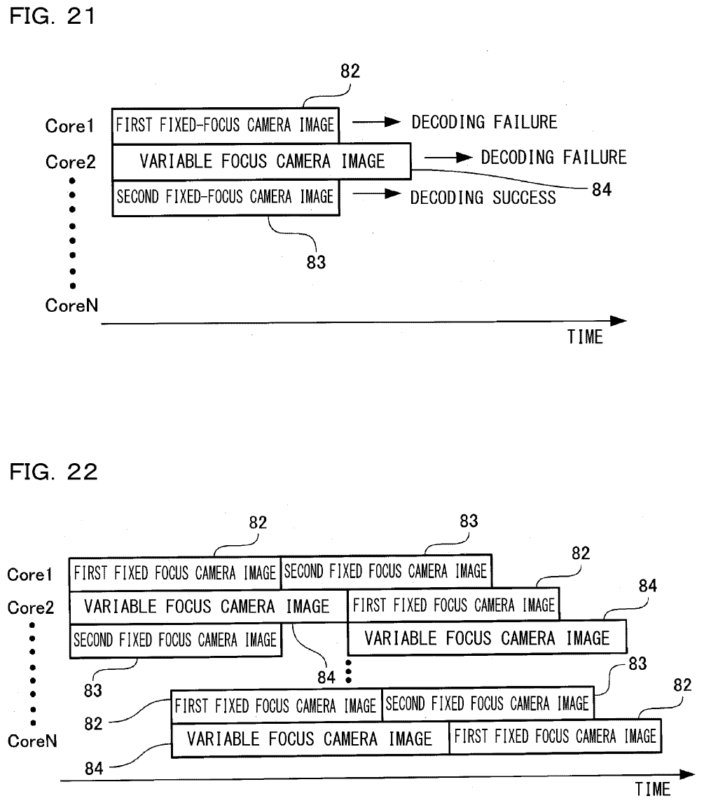

Next, in step S12 of FIG. 19, decoding process of the image data stored in RAM 21 is started. Specifically, in the control device (CPU), cores 27 are assigned to each camera 33, 34, 35, respectively, and parallel decoding process is performed by these multiple cores 27, 27, . . . . In other words, image processing, namely decoding process, is performed simultaneously for the image data acquired by each camera 33, 34, 35. FIG. 21 shows an example of such decoding process. The horizontal direction in the figure represents time. Here, decoding process 82 of the image from the first fixed-focus camera 33, decoding process 83 of the image from the second fixed-focus camera 34, and decoding process 84 of the image from the variable focus camera 35 are started simultaneously. At this time, normally, since the exposure time differs for each camera 33, 34, 35, the time for storage in RAM 21 and the start timing of decoding for the images obtained by each camera 33, 34, 35 differ.

Then, in step S13 of FIG. 19, it is determined whether decoding was successful or not. For example, FIG. 21 shows an example where decoding from the image data of the first fixed-focus camera 33 failed, decoding from the image data of the variable focus camera 35 also failed, but decoding from the image data of the second fixed-focus camera 34 was successful. In this way, if even one decoding is successful, it is determined that decoding was successful in step S13.

Thereby, as shown in step S14, the reading of the image of symbol 11 succeeds, and the process ends in step S15.

If it is determined in step S13 that decoding has failed for the image data of all cameras 33, 34, and 35, the process proceeds to step S16 as “decoding failure”. In this step S16, the brightness of the image captured by the camera is calculated, and the exposure time for the next re-exposure is calculated. Then, the process returns to step S2 and repeats the same process. At this time, if “decoding failure” is determined in step S13, the next focus processing of step S16 and thereafter is performed without waiting for the completion of the decoding process. This enables rapid processing.

FIG. 22 shows an example of decoding process when decoding succeeds after multiple repetitive processes. Here, it is shown that the decoding processes 82, 83, and 84 of images obtained by cameras 33, 34, and 35 are performed simultaneously and repeatedly.

In the second and subsequent processes, in step S3, based on the fact that the symbol 11 could not be read as described above, it is determined that it is necessary to move the focal length position of the variable focus camera 35 to a position other than the predetermined focus position. In this case, after executing steps S5, S6, and S7 as described above, the process proceeds to step S4.

As described above, during the first reading process after the trigger key 18 is operated, the focal length of the variable focus camera 35 is set to a predetermined distance between the focal length of the first fixed focus camera 33 and the focal length of the second fixed focus camera 34, as shown in FIG. 10. In other words, for the first time, processing time can be reduced by adjusting the focus of the variable focus camera 35 to a fixed position without measuring the distance. Conversely, if distance measurement to the symbol 11 and adjustment of the focal length of the variable focus camera 35 are performed from the first time, there is a risk that power consumption may become excessive, or the power source such as a motor in the focal length changing device 47 for adjusting the focal length may deteriorate prematurely.

During the first reading, instead of setting the focal length of the variable focus camera 35 to a predetermined distance between the focal length of the first fixed-focus camera 33 and the focal length of the second fixed-focus camera 34 as shown in FIG. 10, it can be set to the distance of the focus position where decoding was successful in the previous processing. Additionally, in some cases, it may be configured to always execute the processing of steps S5, S6, and S7 even during the first reading. Alternatively, at any stage after the first time, the processing of steps S5, S6, and S7 can be omitted in the same manner as during the first reading.

In the above description, an example was explained where different cores 27 of the control device 20 were assigned to each camera 33, 34, 35, and parallel simultaneous processing was performed by multiple cores 27, 27, . . . . However, if it is possible to perform parallel simultaneous processing similarly with only a single core 27, it is also possible to perform the processing with that single core.

It is preferable that the processing of images acquired by each camera 33, 34, 35 is performed independently for each camera 33, 34, 35 in the control device 20. By enabling independent processing for each camera 33, 34, 35, not only is the aforementioned simultaneous processing possible, but also processing with staggered timing as shown in FIG. 22 can be performed as necessary.

What is claimed is:

1. An optical information reading device that captures an image of a symbol to be read and reads information of the symbol, comprising:
an imaging device and a control device,
wherein the imaging device includes:
a first fixed focus camera including a first fixed focus optical system having a first focal length and receiving reflected light that is incident on the symbol and reflected by the symbol, and a first imaging element that converts light received by the first fixed focus optical system into an electrical signal to generate a first image,
a second fixed focus camera including a second fixed focus optical system having a second focal length longer than the first focal length and receiving reflected light that is incident on the symbol and reflected by the symbol, and a second imaging element that converts light received by the second fixed focus optical system into an electrical signal to generate a second image focused at a longer distance than the first image,
a variable focus camera including a variable focus optical system whose focal length is variable and which receives reflected light that is incident on the symbol and reflected by the symbol, a third imaging element that converts light received by the variable focus optical system into an electrical signal to generate a third image, and a focal length changing device that changes the focal length of the variable focus optical system, and
wherein the control device:
reads information of the symbol based on the first image, the second image, and the third image,
controls the focal length changing device such that the focal length of the variable focus optical system is longer than the first focal length and shorter than the second focal length, and
reads information of the symbol based on the third image focused at a distance farther than the first image and closer than the second image, generated by the variable focus camera under the focal length.

2. The optical information reading device according to claim 1, wherein the control device comprises:
a first image capture interface connected to the first fixed focus camera and acquiring the first image,
a second image capture interface connected to the second fixed focus camera and acquiring the second image,
a third image capture interface connected to the variable focus camera and acquiring the third image,
one or more cores capable of executing decoding processes in parallel on the first image, second image, and third image,
wherein the timing for acquiring the first image, second image, and third image is independent of each other.

3. The optical information reading device according to claim 2, further comprising:
a trigger key operated by an operator to define an imaging timing of the imaging device, wherein the control device, when detecting that the trigger key has been operated, transmits an imaging trigger to expose each of the first fixed focus camera, the second fixed focus camera, and the variable focus camera in parallel.

4. The optical information reading device according to claim 3, further comprising:
an illumination device that irradiates illumination light onto the symbol,
wherein the first imaging element and the second imaging element are global shutter type image sensors, wherein the third imaging element is a rolling shutter type image sensor, wherein
the control device:
causes the illumination device to irradiate the illumination light,
starts exposure in the first fixed-focus camera and the second fixed-focus camera, and
then starts exposure in the variable focus camera after a predetermined period has elapsed.

5. The optical information reading device according to claim 1, wherein the control device controls the focal length changing device such that the focal length of the variable focus optical system becomes shorter than the first focal length, and reads symbol information based on the third image, which is focused at a shorter distance than the first image, generated by the variable focus camera whose focal length is shorter than the first focal length.

6. The optical information reading device according to claim 1, wherein the control device controls the focal length changing device such that the focal length of the variable focus optical system becomes longer than the second focal length, and reads symbol information based on the third image, which is focused at a longer distance than the second image, generated by the variable focus camera whose focal length is longer than the second focal length.

7. The optical information reading device according to claim 1, wherein
the control device:
further includes a focus determination unit for determining the focal length of the variable focus camera,
drives the focal length changing device such that the focal length of the variable focus camera becomes the focal length determined by the focus determination unit, and
transmits an imaging trigger to expose the first fixed focus camera, the second fixed focus camera, and the variable focus camera adjusted to the focal length determined by the focus determination unit in parallel.

8. The optical information reading device according to claim 1, further comprising:
a trigger key operated by an operator to define an imaging timing of the imaging device; and
a storage device that stores information related to a predetermined focal length positioned between the first focal length and the second focal length to realize the predetermined focal length in the variable focus camera,
wherein the control device
upon detecting that the trigger key is operated, at an initial imaging timing, causes the variable focus camera to adjust to the predetermined focal length, and
causes an imaging by the variable focus camera adjusted to the predetermined focal length.

9. The optical information reading device according to claim 1, further comprising:
an illumination device that irradiates illumination light onto the symbol; and
an aiming light irradiation device that irradiates aiming light onto the symbol,
wherein the first fixed focus camera, the second fixed focus camera, the variable focus camera, the illumination device, and the aiming light irradiation device are arranged in a straight line.

10. The optical information reading device according to claim 1, further comprising:
an illumination device that irradiates illumination light onto the symbol; and
an aiming light irradiation device that irradiates aiming light onto the symbol,
wherein the first fixed focus camera, the second fixed focus camera, the variable focus camera, and the illumination device are arranged to surround the aiming light irradiation device.
